(19) United States
(12) Patent Application Publication
(10) Pub. No.: US 2026/0008561 A1
(43) Pub. Date: Jan. 8, 2026

(54) DISPLAY DEVICE FOR A COCKPIT OF AN AIRCRAFT, COCKPIT, AND ASSOCIATED METHOD

(71) Applicant: DASSAULT AVIATION, Paris (FR)

(72) Inventors: Gautier SENCE, Merignac (FR); Hasna NADFAOUI, SAINT-CLOUD CEDRX (FR); Jean-Philippe ROUE, SAINT-CLOUD CEDEX (FR); Pierre-Louis BOUCHUT, Merignac Cedex (FR); Eric BOULLE, Istres Cedex (FR)

(21) Appl. No.: 19/259,946

(22) Filed: Jul. 3, 2025

(30) Foreign Application Priority Data
Jul. 8, 2024 (FR) FR 2407421

(51) Int. Cl. B64D 43/02; G08B 7/06

(52) U.S. Cl. CPC B64D 43/02; G08B 7/06

(57) ABSTRACT

A device including a display management system, configured to display on at least one of a first dedicated display area and a second dedicated display area, an alert indication corresponding to alert information received from an avionics central unit. It is configured to receive role information of the crew member present respectively on a first seat located in front of the first dedicated display area and on a second seat located in front of the second dedicated display area. The display management system is configured to display an alert indication corresponding to the received alert information, on at least one of the first dedicated display area and the second dedicated display area, defined based on the role information of the crew member present respectively in front of the first dedicated display area and the second dedicated display area.

### TECHNICAL FIELD

This present disclosure relates to a display device for a cockpit of an aircraft including:
at least one first dedicated display area intended to be placed in front of a first seat of the cockpit;
at least one second dedicated display area intended to be placed in front of a second seat of the cockpit;
a display management assembly, configured to display on the first dedicated display area and on the second dedicated display area at least one flight parameter of the aircraft, and/or at least one navigation or/and guidance parameter of the aircraft or/and at least one maintenance parameter of the aircraft; the display management assembly being configured to receive alert information from an avionics central unit and to display on at least one of the first dedicated display area and the second dedicated display area, at least one alert indication corresponding to a received piece of alert information.

Such a display device, placed in the cockpit of an aircraft, is intended to improve coordination between aircraft crew members, especially during flight phases of the aircraft where crew members are subject to high demands.

### BACKGROUND

Traditionally, piloting, navigation, communication, and management of aircraft systems are ensured by two crew members who divide the various tasks.

A first crew member is dedicated, for example, to piloting and monitoring flight parameters, while a second crew member ensures ground communications, aircraft systems management, surveillance activities, and other tasks not directly related to piloting.

To assist the crew members in piloting the aircraft, each has, in front of the seat on which he/she is sitting, a dedicated display area showing, for example, altitude indicators, horizontal situation, airspeed, vertical speed as well as engine information, lift and landing gear configurations of the aircraft, or/and guidance parameters of the aircraft, especially during an approach.

The different indicators displayed on each dedicated display area are generally the same for each pilot. However, at least some of these indicators are developed from distinct sensors and/or sources to ensure redundancy of measurements. This allows potential erroneous measurements from a faulty sensor or source to be detected and prevents them from being used in the displaying of the two display areas.

For example, during the approach of an aircraft to a runway, guidance systems can be used to guide the aircraft to the runway. These guidance systems comprise, for example, an instrument landing system or “ILS”, which requires the ground station beam near the runway to be detected.

The aircraft is equipped with at least two guidance receivers (also called “guidance sensor” or “guidance source”), each receiver being intended to be used by a respective pilot when both receivers are functioning.

During an instrument approach to the runway, both the pilot flying and the pilot non-flying detect the ground station beam through distinct paths using a separate receiver to independently follow the guidance to the runway on their dedicated display area. The two aircraft receivers are set to detect the same ground station by being connected to the ILS frequency.

The guidance indications presented to each pilot are constructed based on what is detected by the respective receiver used by the pilot, translated into lateral and vertical deviation information.

In the event the pilot flying loses approach guidance, for example, due to a failure of the receiver allocated to their approach side, an alert indicator is then displayed on the dedicated display area of the pilot flying and is accompanied by an auditory alert to signal the loss of approach capability.

The pilot flying must then interrupt the approach and no longer use the faulty receiver and replace it with the other receiver or choose another approach category, for example, visual.

In existing display devices, if the pilot non-flying loses approach guidance, an alert indicator of the same level as that dedicated to the pilot flying is also displayed on his/her dedicated display area, and the same auditory alert as that applied for the pilot flying is generally emitted.

However, the loss by the pilot non-flying of his/her allocated receiver does not generally require an interruption of the landing, as long as the pilot flying still detects the guidance receiver they are following.

In theory, the pilot flying can continue the landing despite the alarm indications presented to the pilot non-flying and despite the auditory alert broadcast in the cockpit.

In practice, the presence of an alert indication on the dedicated display area of the pilot non-flying, associated with an auditory indication in the cockpit, may disturb the pilot flying and lead them to cancel the landing as a precaution, even though the cause of the alert does not justify it.

### SUMMARY

A goal of the present disclosure is therefore to provide display device for a cockpit of an aircraft, that improves coordination between crew members and reduces the high demands on their attention, particularly by limiting unnecessary responses to certain non-critical alerts.

To this end, the present disclosure provides a display device for a cockpit of an aircraft that includes at least one first dedicated display area intended to be placed in front of a first seat of the cockpit; at least one second dedicated display area intended to be placed in front of a second seat of the cockpit; and a display management assembly, configured to display on the first dedicated display area and on the second dedicated display area at least one flight parameter of the aircraft, or/and at least one navigation or/and guidance parameter of the aircraft or/and at least one maintenance parameter of the aircraft. The display management assembly is configured to receive alert information from an avionics central unit and to display on at least one of the first dedicated display area and the second dedicated display area, at least one alert indication corresponding to a received piece of alert information. The display management assembly is configured to receive a piece of role information for each crew member present respectively on the first seat and on the second seat and is configured to display an alert indication corresponding to the received piece of alert information, on at least one of the first dedicated display area and the second dedicated display area, the alert indication being defined based on the piece of role information for the crew member present respectively in front of the first dedicated display area and the second dedicated display area.

The display device according to the present disclosure can comprise one or more of the following features, taken alone or in any technically possible combination wherein:
upon receiving the piece of alert information, the display management assembly:
   is configured to display a first alert indication corresponding to the piece of alert information when the piece of role information corresponds to a first role; and
   is configured to display a second alert indication corresponding to the piece of alert information when the piece of role information corresponds to a second role, the second alert indication being distinct from the first alert indication, or
   is configured not to display an alert indication corresponding to the piece of alert information when the piece of role information corresponds to the second role;
the first role is pilot flying, and the second role is pilot non-flying;
the first alert indication is configured to generate an immediate awareness of the alert by the crew member, for example, by a red or amber color code, the second alert indication being configured to generate a non-necessarily immediate awareness of the alert by the crew member, for example, by a color code distinct from red, amber, and green;
the first alert indication and the second alert indication comprise an identical alphanumeric text corresponding to the piece of alert information;
the first alert indication is a warning indication or a caution indication for the crew member, and the second alert indication is an advisory indication for the crew member;
   the display management assembly:
      is configured to generate a first auditory or/and haptic alert in addition to the first alert indication; and
      is configured to generate a second auditory or/and haptic alert in addition to the second alert indication, the second auditory or/and haptic alert being distinct from the first auditory or/and haptic alert, or
      is configured not to generate an auditory or/and haptic alert in addition to the second alert indication;
the display management assembly is configured to display on the first dedicated display area and/or the second dedicated display area flight parameter windows displaying at least one of the following parameters: altitude indicator, horizontal situation indicator, airspeed, vertical speed, corrected airspeed, fuel quantity, engine information, lift and/or landing gear configuration of the aircraft;
the alert indication is an alert indication related to aircraft navigation parameters, an alert indication related to guidance or/and communication parameters of the aircraft, or/and an alert indication related to defects or failures of at least one piece of equipment for the aircraft.

The present disclosure also relates to an aircraft cockpit including:
a display device as defined above;
an avionics central unit configured to be connected to sensor systems for measuring aircraft parameters, to external communication and guidance systems, to aircraft control systems, and/or to aircraft system monitoring and management systems, the avionics central unit being configured to acquire or generate at least one piece of alert information from data coming from the sensor systems for measuring aircraft parameters, the external communication and guidance systems, the aircraft control systems, and/or the aircraft system monitoring and management systems.

The aircraft cockpit according to the present disclosure can comprise the following feature:
a first seat placed in front of the first dedicated display area, a second seat placed in front of the second dedicated display area, and an input or/and detection system for entering or/and detecting the role of each crew member sitting respectively on the first seat and on the second seat.

The present disclosure also relates to a method for displaying alert indications on a display device in an aircraft cockpit, the method comprising the following steps:
display, by a display management assembly, on a first dedicated display area and on a second dedicated display area of at least one flight parameter of the aircraft, or/and at least one navigation parameter of the aircraft, or/and at least one system status parameter of the aircraft;
   receipt, by the display management assembly, of at least one piece of alert information from an avionics central unit and display on at least one of the first dedicated display area and the second dedicated display area, of at least one alert indication corresponding to the received piece of alert information; characterized by the receipt, by the display management assembly, of a piece of role information for each crew member present respectively on the first seat and on the second seat and by the display of an alert indication corresponding to the received piece of alert information on at least one of the first dedicated display area and the second dedicated display area which is defined based on the piece of role information for the crew member present respectively in front of the first dedicated display area and the second dedicated display area.

The method according to the present disclosure can comprise one or more of the following features, taken alone or in any technically possible combination wherein:
the display, by the display management assembly, upon receipt of the piece of alert information, of a first alert indication corresponding to the piece of alert information when the piece of role information corresponds to a first role; and the display of a second alert indication corresponding to the piece of alert information when the piece of role information corresponds to a second role, the second alert indication being distinct from the first alert indication, or an absence of display of an alert indication corresponding to the piece of alert information when the piece of role information corresponds to the second role;
the display of the first alert indication with a configuration generating an immediate awareness of the alert by the crew member, for example, by a red or amber color code, and the display of the second alert indication with a configuration generating a non-necessarily immediate awareness of the alert by the crew member, for example, by a color code distinct from red, amber, and green;
the display of the first alert indication and the second alert indication comprises the display of an identical alphanumeric message for the first alert indication and for the second alert indication.

### BRIEF SUMMARY OF THE DRAWINGS

The present disclosure will be better understood by reading the following description, given only as an example, and made with reference to the attached drawings wherein:

FIG. 1 is a simplified perspective view of an aircraft cockpit comprising a first display device according to the present disclosure;

FIG. 2 is a block diagram illustrating the components of the display device according to the present disclosure;

FIG. 3 is a view representing a first display area placed in front of the pilot flying and a second display area placed in front of the pilot non-flying during an aircraft approach, in case of loss of a guidance receiver allocated to the pilot flying;

FIG. 4 is a view similar to FIG. 3, in case of loss of a guidance receiver allocated to the pilot non-flying; and

FIG. 5 is a view illustrating some steps of a display method according to the present disclosure, implemented using the display device from FIG. 2.

### DETAILED DESCRIPTION

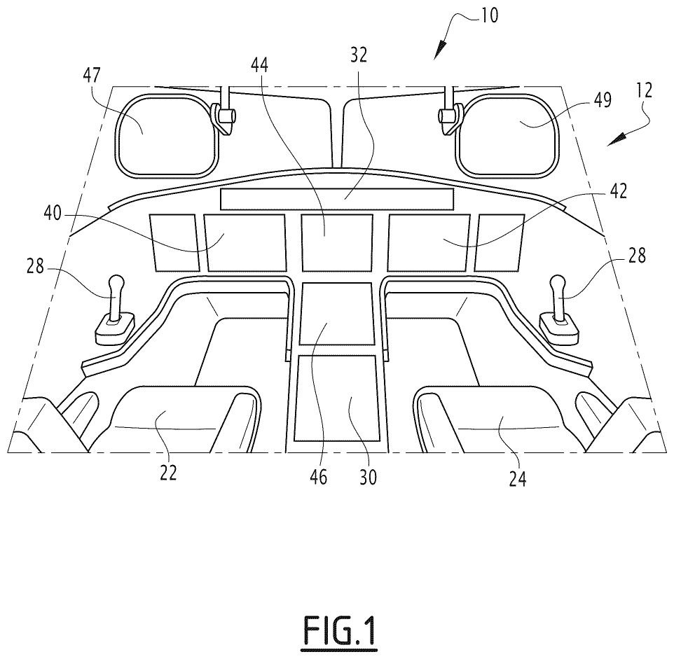

A first display device 10 according to the present disclosure is intended to be placed in a cockpit 12 of an aircraft schematically represented in FIG. 1.

The cockpit 12 is located in the aircraft or in a ground control room.

The display device 10 is intended to allow the crew to pilot the aircraft, manage its navigation, and communication, and monitor and control the various aircraft systems present in the aircraft.

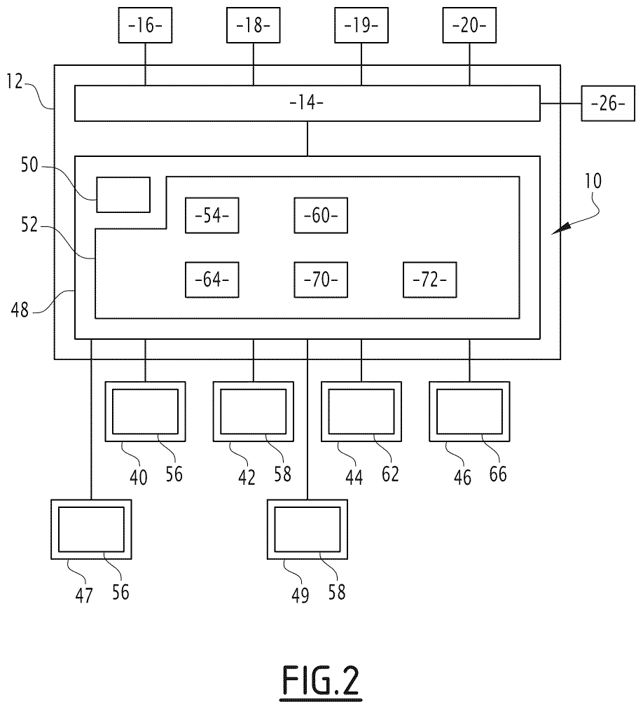

As illustrated by FIG. 2, the cockpit 12 includes, in addition to the display device 10, an avionics central unit 14 intended to communicate with aircraft systems, particularly with sensor systems 16 for measuring aircraft parameters, with external communication and guidance systems 18, with aircraft control systems 19, and with aircraft system monitoring and management systems 20, particularly for detecting defects and failures of aircraft equipment.

Referring to FIG. 1, the cockpit 12 includes a first seat 22 intended for a first crew member of the aircraft, and a second seat 24 intended for a second crew member of the aircraft, the two seats being placed side by side.

The cockpit 12 is also equipped with a control device 28 for piloting the aircraft associated with each seat 22, 24, a throttle lever (not shown), and a human-machine interface 30. It advantageously includes an automatic pilot system 32 configured to be activated by the crew.

As visible in FIG. 2, the cockpit 12 also includes an input or/and detection system 26 for entering and/or detecting the role of each crew member sitting respectively on the first seat 22 and on the second seat 24. The system 26 is configured to define a role for the crew member on each respective seat 22, 24, as pilot flying or as a pilot non-flying.

The sensor systems 16 include, for example, sensors for measuring parameters external to the aircraft, such as temperature, pressure, or speed, sensors for measuring parameters internal to the aircraft and its various functional systems, and positioning sensors, such as GPS sensors, inertial units, and/or an altimeter.

The external communication and guidance systems 18 comprise, for example, VOR/LOC radio systems, ADS, DME, ILS, NLS, or/and radar systems. These systems notably comprise guidance receivers configured to detect a guidance beam emitted by a ground station near a runway to indicate a guidance direction.

The control systems 19 comprise actuators specific to actuating aircraft controls, such as flaps, rudders, pumps, or even mechanical, electrical, or/and hydraulic circuits, and software actuators specific to configuring the avionics statuses of the aircraft.

The aircraft monitoring and management systems 20 include status, defect, or/and failure sensors for the various pieces of equipment present in the aircraft systems, for example in the sensor systems 16, in the communication systems 18, and in the control systems 19.

The different systems 16, 18, 19, 20, 26 are connected to the avionics central unit 14, for example digitally, by at least one data bus circulating on an internal network of the aircraft.

The avionics central unit 14 comprises at least one calculator, preferably at least two calculators, each calculator comprising at least one processor and a memory able to receive data from the different systems 16, 18, 19, 20, 26 and processing them, to possibly control aircraft systems and execute flight commands.

The avionics central unit 14 is also configured to acquire or produce alert information, using data received from the measurement sensor systems 16, particularly related to navigation parameters, for example due to excessive speed, unusual altitude, excessive deviation from a heading, proximity to terrain, proximity to another aircraft or other traffic elements.

The avionics central unit 14 is also configured to acquire or produce alert information using data from external communication and guidance systems 18, for example, in case of guidance failure, particularly in case of failure occurring in detection by a guidance receiver during an instrument landing.

The avionics central unit 14 is also configured to acquire or produce alert information using data from control systems 19 or/and monitoring and management systems 20, in case of defect or failure of equipment on the aircraft.

In the example shown in FIG. 1, the display device 10 includes at least one first dedicated display area 40, intended to be placed in front of a first crew member, in front of the first seat 22 of the cockpit 12, at least one second dedicated display area 42, intended to be placed in front of a second crew member, in front of a second seat 24 of the cockpit 12, and at least one display area 44, 46 visible to both crew members, placed between the first display area 40 and the second display area 42.

The display device 10 also includes in this example a first dedicated head-up display area 47, intended to be placed in front of the first seat 22 and a second dedicated head-up display area 49, intended to be placed in front of the second seat 24.

The display device 10 also includes a display management assembly 48 dedicated to controlling the display on the different display areas 40 to 49.

In the example shown in FIG. 1, the display device 10 includes an upper shared display area 44 and a lower shared display area 46 located below the upper area 44 and below the first and second display areas 40, 42.

In the example shown in FIG. 1, the display areas 40 to 46 are located on separate screens, each screen corresponding to a display area 40 to 46.

The first dedicated display area 40 and the second dedicated display area 42 are generally defined by primary display screens, located in front of the seat 22, 24 of each respective crew member.

The upper display area 44 visible to both crew members and the lower area 46 visible to both crew members are defined respectively on a multifunctional navigation screen and on a control and/or monitoring screen for the aircraft systems.

Alternatively, the display areas 40 to 46 are located on a single common screen, for example, in a T-shape.

Each of the dedicated head-up display areas 47, 49 is, for example, placed on a semi-transparent head-up screen placed in front of the windshield, on an image projection surface on the cockpit 12 windshield, on a semi-transparent sun visor, a helmet visor, or a semi-transparent scope close to the eye.

The display areas 40, 47 are thus dedicated to the first crew member sitting in the first seat 22, while the display areas 42, 49 are dedicated to the second crew member sitting in the second seat 24.

Each display area 40 to 49 is connected to the display management assembly 48 to be controlled by the display management assembly 48.

The display management assembly 48 is connected to the avionics central unit 14 to receive data from the different systems 16, 18, 19, 20, 26 of the aircraft, particularly the pieces of alert information acquired or produced by the avionics central unit 14.

Referring to FIG. 2, the display management assembly 48 includes at least one processor 50, and a memory 52 including software modules specific to being executed by the processor 50.

Alternatively, the display management assembly 48 is made in the form of at least one programmable logic component, such as an FPGA (from “Field Programmable Gate Array”) or even a dedicated integrated circuit, such as an ASIC (from “Application Specific Integrated Circuit”), which allows the functions of the command device modules to be performed.

To this end, the display management assembly 48 comprises a display module 54 of at least one flight parameter window 56 on the first dedicated display area 40 and/or on the first dedicated head-up display area 47, and of at least one flight parameter window 58 on the second dedicated display area 42 and/or on the second dedicated head-up display area 49.

The display management assembly 48 also comprises a module 60 for displaying at least one navigation window 62 on the upper display area 44 visible to both crew members and a module 64 for displaying at least one aircraft system monitoring and/or control window 66 on the lower display area 46 visible to both crew members.

The display management assembly 48 also comprises a module 70 for generating and displaying alert indications corresponding to each piece of alert information issued by the avionics central unit 14.

According to the present disclosure, each alert indication displayed on a display area 40, 42, 47, 49 dedicated to a crew member in front of a respective seat 22, 24 is defined based on a role of each pilot present respectively in front of the dedicated display area 40, 42, 47, 49.

The display management assembly 48 also comprises an activation module 72 for activating an auditory or/and haptic alert, in addition to the alert indication displayed on a display area 40 to 49.

The windows 56, 58, 62, 66 are, for example, frames wherein graphic elements are displayed. They occupy all or part of the display area 40 to 49 wherein they are displayed.

The graphic elements are chosen from alphanumeric indicators, analog indicators like gauges, commands or menus actionable by the user, for example, by selecting the command using a human-machine interface, symbols or icons specific to forming a display shortcut of another window distinct from the current window, or/and alphanumeric data entry fields using the human-machine interface.

The flight parameter windows 56, 58 are intended to be displayed either permanently during normal operation of the aircraft, regardless of the operational status of the aircraft, or to be displayed on pilot selection.

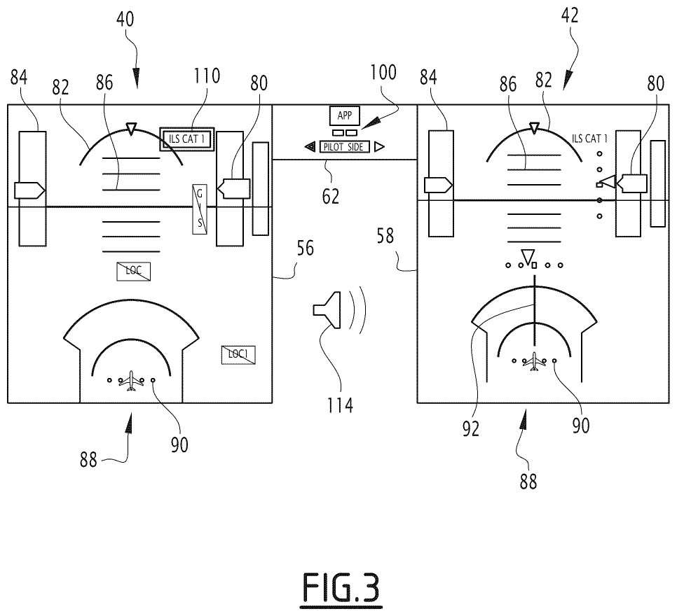

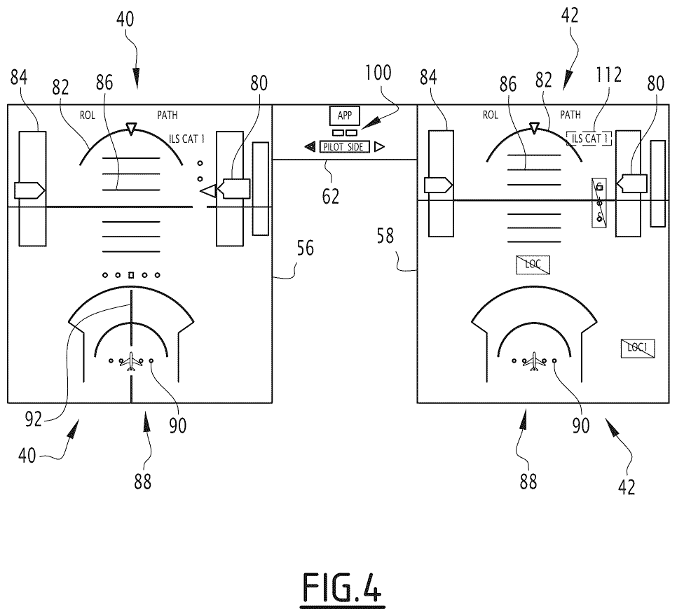

In the example shown in FIGS. 3 and 4, the flight parameter windows 56, 58 generally present at least one of the following graphic elements: altitude indicator 80, heading indicator 82, airspeed indicator 84, slope indicator 86, engine information, fuel quantity, and lift configuration, as well as the landing gear of the aircraft.

They include in this example, in the case of a guided approach to an aircraft runway using a localization beam, for example, ILS, a guidance indicator 88 to the localization beam, comprising, for example, a deviation scale 90 around the desired guidance direction relative to the beam and a positioning symbol 92 of the aircraft relative to the guidance direction, in reference to the deviation scale 90. In this case, the positioning symbol is a vertical segment.

In the example shown in FIGS. 3 and 4, the flight parameter windows 56, 58 displayed respectively on the first dedicated display area 40 and the second dedicated display area 42 display the same flight parameters. However, these flight parameters are advantageously determined by the avionics central unit 14 from data coming from partially or totally distinct measurement sensors.

The navigation windows 62 and the monitoring command windows 66 are specific to being selectively displayed by the user, particularly by using the human/machine interface.

The navigation windows 62 include, for example, graphic elements chosen from navigation display data coming from a storage database, vertical and horizontal situation indicators, and heading and positioning indicators relative to ground reference points, such as radio beacons. The navigation windows 62 also comprise radar data display systems captured by the aircraft.

The navigation window 62 also includes in this example, a role definition indicator 100 of the pilot in front of each seat 22, 24, which defines the role of each pilot, based on the role information obtained from the role input and detection system 26.

For example, here the definition indicator 100 includes an arrow directed towards the seat 22, 24 for the pilot flying and an alphanumeric indication (here the English term “PILOT SIDE”) indicating that it is the side for the pilot flying.

The monitoring command windows 66 generally comprise graphic elements chosen from numerical indicators related to different parameters measured on the aircraft systems, representation and command diagrams of different hydraulic, electrical, fuel, engine, cabin pressurization, mechanical, or avionics systems present in the aircraft, indicators of present fuel level, and possibly, display windows of procedures to be carried out coming from an aircraft procedures database.

Some of the windows 62, 66 present on the respective shared display areas 44, 46 are specific to being replaced by other windows generated by the display module 64 and invisible on the display areas 44, 46 when the windows 62, 66 are present.

Upon receiving a piece of alert information from the avionics central unit 14, the alert indication generation and display module 70 is configured to display on at least one window 56, 58 of the dedicated display areas 40, 42, 47, 49, a visual alert indication that depends on the piece of alert information and that, according to the present disclosure, depends on a piece of role information for the crew member present on the first seat 22 and on the second seat 24 placed in front of the dedicated display area 40, 42, 47, 49.

The piece of role information is acquired by the alert indication generation and display module 70 from the role input and detection system 26.

The alert indication is, for example, an alert message, a flag, an announcement, a symbol, or a pop-up window configured to be displayed on the window 56, 58.

The alert indication advantageously presents a level of criticality chosen from a warning, caution, or advisory indication.

The alert indication is, for example, a warning indication 110 (designated by the English term “warning”, see FIG. 3), a caution indication (designated by the English term “caution”) or even an informative indication 112 (see FIG. 4, designated by the English term “advisory”).

These indications are, for example, indications that follow the CS25.1322 regulation issued by the EASA, which classifies them according to the immediacy of crew member awareness or/and the response required from the crew member.

A warning indication 110 corresponds to a piece of alert information that requires immediate awareness by the crew member and an immediate response from this crew member.

A caution indication corresponds to a piece of alert information that requires immediate awareness by the crew member and a later response from this crew member.

An advisory indication 112 corresponds to a piece of alert information that requires awareness by the crew member and possibly a response from this crew member.

Each alert indication generally presents an alphanumeric text and a color code associated with the background or the text color that corresponds to the level of criticality of the alert indication.

Thus, a warning indication 110 is generally colored in red (represented in double lines on FIG. 3), a caution indication is generally colored in amber or orange and an advisory indication 112 is generally colored in a color other than red, amber, orange, or green (represented in dotted lines on FIG. 4).

The alert indication, particularly the alphanumeric text and/or the color code with which the alphanumeric text is displayed are configured by the alert indication generation and display module 70, using the piece of role information received from the input and role detection system 26.

Thus, for the same received piece of alert information, the alert indication generation and display module 70 is configured to generate a first alert indication intended to be displayed on a display area 40, 47; 42, 49 dedicated to a crew member, when the crew member occupies a first role, and to generate a second alert indication distinct from the first alert indication, intended to be displayed on a display area 40, 47; 42, 49 dedicated to a crew member when the crew member occupies a second role distinct from the first role.

Thus, when a given piece of alert information is acquired or generated by the avionics central unit 14, a crew member sitting in a respective seat 22, 24 and looking at a dedicated display area 40, 47; 42, 49, located in front of the respective seat 22, 24, will be able to observe a first alert indication displayed on the dedicated display area 40, 47; 42, 49 when they occupy a first role (for example pilot flying) following receipt of the given piece of alert information and a second alert indication displayed on the dedicated display area 40, 47; 42, 49 when they occupy a second role (for example pilot non-flying) following receipt of the same given alert information.

The first alert indication differs from the second alert indication, for example, by its color code or/and by its alphanumeric text.

For example, for the same received piece of alert information, the alert indication generation and display module 70 is configured to generate a warning indication 110 on the dedicated display area 40, 47; 42, 49 in front of the seat 22, 24 when the crew member has the role of pilot flying, and a caution or advisory indication 112, when the crew member has the role of pilot non-flying.

Alternatively, for the same received piece of alert information, the alert indication generation and display module 70 is configured to generate a caution indication on the dedicated display area 40, 47; 42, 49 in front of the seat 22, 24 when the crew member has the role of pilot flying, and an advisory indication 112, when the crew member has the role of pilot non-flying.

In particular, this allows the pilot flying to avoid being disturbed by alert or caution indications displayed on the dedicated display area 40, 47; 42, 49 for a pilot non-flying for which the alert does not justify awareness and possibly an immediate response from the pilot non-flying, while it would require awareness and possibly an immediate response from the pilot flying if it were intended for them.

The activation module of an auditory or/and haptic alert 72 is configured to generate, depending on the level of criticality of the alert indication displayed on a display area 40 to 49, an auditory or/and haptic alert 114, schematically represented in FIG. 3.

For example, if the level of criticality corresponds to a warning or caution indication, the auditory or/and haptic alert 114 is generated. On the other hand, if the level of criticality corresponds to an advisory indication, no auditory or/and haptic alert is generated.

A method for displaying alert indications in an aircraft cockpit 12 will now be described.

At the beginning of each flight or during the flight, the aircraft crew defines the role of each crew member sitting in a respective seat 22, 24 as either “pilot flying” or “pilot non-flying” and enters this role using the role input or detection system 26. Alternatively, the role input and detection system 26 assigns the role of pilot flying to the crew member sat in the left seat.

Subsequently, during taxiing and then during the flight, the avionics central unit 14 receives data from the sensor systems 16, the communication systems 18, the aircraft control systems 19, and the aircraft system monitoring and management systems 20.

The avionics central unit 14 detects the presence of alerts, for example, related to the navigation of the aircraft, its guidance, or defects and/or failures affecting the aircraft equipment, using the data received from the systems 16, 18, 19, 20.

When an alert is detected, the avionics central unit 14 acquires or generates a piece of alert information corresponding to the detected alert.

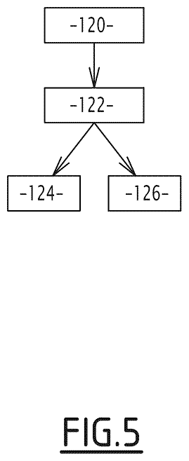

At step 120 on FIG. 5, this alert information is transmitted to the alert indication generation and display module 70.

At step 122, the module 70 then determines on which dedicated display area 40, 47; 42, 49, an alert indication corresponding to the received piece of alert information should be displayed, and the role of the crew member sitting in the seat 22, 24 placed in front of the dedicated display area 40, 47; 42, 49.

Depending on the dedicated display area 40, 47; 42, 49 on which the indication should be displayed, and the role of the pilot present in front of this display area 40, 42, the alert indication generation and display module 70 generates at step 124 a first alert indication in the case where the crew member occupies a first role, or generates at step 126 a second alert indication, distinct from the first alert indication when the crew member occupies a second role.

For example, the alert indication generation and display module 70 generates a warning indication 110, preferably with a red color code, when the role of the crew member is “pilot flying” or a caution indication, preferably with an orange or amber color code.

The activation module of an auditory or/and haptic alert 72 then generates an auditory or/and haptic alert 114.

On the other hand, the alert indication generation and display module 70 generates an advisory indication 112, preferably with a color code distinct from red and green, when the crew member is the “pilot non-flying”.

No auditory or/and haptic alert is then generated by the activation module for an auditory or/and haptic alert 72, in the case where an advisory indication is displayed.

In the particular example shown in FIGS. 3 and 4, the pilot flying is sitting on the left, in the first seat 22, and the pilot non-flying is sitting on the right, in the second seat 24, as indicated by the role indicator 100.

Referring to FIG. 3, when the avionics central unit 14 detects a loss of detection by the guidance receiver selected by the crew member sitting in the seat 22, it emits a piece of alert information corresponding to a loss affecting this guidance receiver.

The alert indication generation and display module 70 determines that the guidance receiver whose reception has been lost is the one selected by the crew member located in front of the seat 22 and that an alert indication should be displayed on the dedicated display area 40, 47 located in front of the seat 22.

The alert indication generation and display module 70 also determines that the role of the crew member sitting in the seat 22 is “pilot flying”. It therefore displays a warning indication 110 on the dedicated display area 40, 47 located in front of the seat 22.

In the example, the warning indication 110 comprises an alphanumeric message “ILS CAT 1”, which corresponds to the loss of reception by a guidance receiver.

This warning indication 110 is preferably colored in red to signal to the pilot flying sitting in the seat 22 that they must immediately become aware of this alert indication and respond immediately to this alert indication.

The activation module of an auditory or/and haptic alert 72 generates in parallel an auditory or/and haptic alert 116.

In the example shown, this leads the pilot flying to immediately interrupt the approach, especially if they do not see the runway.

The pilot non-flying sitting in the seat 24 does not receive any alert.

Referring to FIG. 4, if the avionics central unit 14 detects a loss of detection by the guidance receiver selected by the crew member sitting in the seat 24, it also emits a piece of alert information corresponding to a loss affecting this guidance receiver.

The alert indication generation and display module 70 determines that the guidance receiver whose reception has been lost is the one selected by the crew member located in front of the seat 24 and that an alert indication should be displayed on the dedicated display area 42, 49 located in front of the seat 24.

The alert indication generation and display module 70 also determines that the role of the crew member sitting in the seat 22 is “pilot non-flying”. It therefore displays an advisory indication 112 on the dedicated display area 42, 49 located in front of the seat 24.

In the example, the advisory indication 112 comprises a text message “ILS CAT 1” identical to that of the warning indication 110, which corresponds to the alert information of a loss of reception by a guidance receiver.

However, this advisory indication 112 is not colored in red, nor in orange or amber. The pilot non-flying is informed of the absence of detection, but this does not require immediate awareness or an immediate response, especially from the pilot flying.

The activation module for an auditory or/and haptic alert 72 remains inactive.

The pilot flying sitting in the seat 22 does not receive any alert. Moreover, they are not impacted by the alert affecting the pilot non-flying. The approach of the pilot flying to the runway is not disturbed and the pilot flying can continue the landing.

Conversely, the pilot non-flying can handle the alert affecting them, without impacting the pilot flying.

Thus, according to the present disclosure just described, the alert indications displayed to a particular crew member are adapted to the role of this crew member who specifically sees this alert indication on a display area 40, 47; 42, 49 dedicated to this crew member.

Depending on the role of the crew member, the degree of criticality of the alert indication is adjusted, particularly between a warning indication 110 requiring immediate awareness and an immediate response or less critical alert indications, such as a caution indication or an advisory indication 112.

The information presented to each crew member is therefore adapted to their role, which avoids unnecessarily disturbing the pilot flying in conducting the flight, while allowing the pilot non-flying to handle the alert indications they receive at the appropriate time.

Thus, the alert level displayed to each crew member is adapted to the particular situation of this crew member and effectively corresponds to the actions that must be taken in response. Thus, the crew members have a better understanding of the criticality of the alert to handle it in the most appropriate way.

Alternatively, for the same received alert information, the alert indication generation and display module 70 is configured to generate a first alert indication intended to be displayed on a display area 40, 47; 42, 49 dedicated to a crew member when the crew member occupies a first role, and not to generate an alert indication intended to be displayed on a display area 40, 47; 42, 49 dedicated to the crew member when the crew member occupies a second role distinct from the first role.

What is claimed is:

1. A display device for a cockpit of an aircraft including:
at least one first dedicated display area intended to be placed in front of a first seat of the cockpit;
at least one second dedicated display area intended to be placed in front of a second seat of the cockpit; and
a display management assembly, configured to display on the first dedicated display area and on the second dedicated display area at least one flight parameter of the aircraft, or/and at least one navigation or/and guidance parameter of the aircraft or/and at least one maintenance parameter of the aircraft;
the display management assembly being configured to receive alert information from an avionics central unit and to display on at least one of the first dedicated display area and the second dedicated display area, at least one alert indication corresponding to a received piece of alert information;
wherein the display management assembly is configured to receive a piece of role information for each crew member present respectively on the first seat and on the second seat and is configured to display an alert indication corresponding to the received piece of alert information, on at least one of the first dedicated display area and the second dedicated display area, the alert indication being defined based on the piece of role information for the crew member present respectively in front of the first dedicated display area and the second dedicated display area.

2. The display device according to claim 1, wherein, upon receipt of the piece of alert information, the display management assembly
is configured to display a first alert indication corresponding to the piece of alert information when the piece of role information corresponds to a first role; and
is configured to display a second alert indication corresponding to the piece of alert information when the piece of role information corresponds to a second role, the second alert indication being distinct from the first alert indication; or
is configured not to display an alert indication corresponding to the alert information when the piece of role information corresponds to the second role.

3. The display device according to claim 2, wherein the first role is pilot flying, and the second role is pilot non-flying.

4. The display device according to claim 2, wherein the first alert indication is configured to generate an immediate awareness of the alert information by the crew member, the second alert indication being configured to generate a non-necessarily immediate awareness of the alert information by the crew member.

5. The display device according to claim 4, wherein the first alert indication is configured to generate an immediate awareness of the alert information by the crew member by a red or amber color code.

6. The display device according to claim 4, wherein the second alert indication is configured to generate a non-necessarily immediate awareness of the alert information by the crew member by a color code distinct from red, amber, and green.

7. The display device according to claim 2, wherein the first alert indication and the second alert indication comprise an identical alphanumeric text corresponding to the piece of alert information.

8. The display device according to claim 2, wherein the first alert indication is a warning indication or a caution indication for the crew member, the second alert indication being an advisory indication for the crew member.

9. The display device according to claim 2, wherein the display management assembly is configured to generate a first auditory or/and haptic alert in addition to the first alert indication; and
is configured to generate a second auditory or/and haptic alert in addition to the second alert indication, the second auditory or/and haptic alert being distinct from the first auditory or/and haptic alert; or
is configured not to generate an auditory or/and haptic alert in addition to the second alert indication.

10. The display device according to claim 1, wherein the display management assembly is configured to display on the first dedicated display area and/or the second dedicated display area flight parameter windows displaying at least one of the following parameters: altitude indicator, horizontal situation indicator, airspeed, vertical speed, corrected airspeed, fuel quantity, engine information, lift and/or landing gear configuration of the aircraft.

11. The display device according to claim 1, wherein the alert indication is an alert indication related to aircraft navigation parameters, an alert indication related to guidance or/and communication parameters of the aircraft, or/and an alert indication related to defects or failures of at least one equipment of the aircraft.

12. An aircraft cockpit including:
a display device according to claim 1;
an avionics central unit configured to be connected to sensor systems for measuring aircraft parameters, to external communication and guidance systems, to aircraft control systems, and/or to aircraft system monitoring and management systems, the avionics central unit being configured to acquire or generate at least one piece of alert information from data coming from the sensor systems for measuring aircraft parameters, the external communication and guidance systems, the aircraft control systems, and/the or aircraft system monitoring and management systems.

13. The aircraft cockpit according to claim 12, including a first seat placed in front of the first dedicated display area, a second seat placed in front of the second dedicated display area, and an input or/and detection system for entering or/and detecting the role of each crew member sitting respectively in the first seat and in the second seat.

14. A method for displaying alert indications on a display device in an aircraft cockpit, the method comprising:
displaying, by a display management assembly, on a first dedicated display area and on a second dedicated display area of at least one flight parameter of the aircraft, or/and at least one navigation parameter of the aircraft, or/and at least one system status parameter of the aircraft;
receiving, by the display management assembly, of at least one piece of alert information from an avionics central unit and displaying on at least one of the first dedicated display area and the second dedicated display area, of at least one alert indication corresponding to the received piece of alert information;
wherein the method comprises receipt, by the display management assembly, of a piece of role information for each crew member present respectively on a first seat and on a second seat and the display of an alert indication corresponding to the received piece of alert information on at least one of the first dedicated display area and the second dedicated display area, which is defined based on the piece of role information for the crew member present respectively in front of the first dedicated display area and the second dedicated display area.

15. The method according to claim 14, comprising the display, by the display management assembly, upon receipt of the piece of alert information, of a first alert indication corresponding to the piece of alert information when the piece of role information corresponds to a first role; and comprising the display of a second alert indication corresponding to the piece of alert information when the piece of role information corresponds to a second role, the second alert indication being distinct from the first alert indication, or comprising an absence of display of an alert indication corresponding to the piece of alert information when the piece of role information corresponds to the second role.

16. The method according to claim 15, comprising the display of the first alert indication with a configuration generating an immediate awareness of the alert by the crew member, for example, by a red or amber color code, and the display of the second alert indication with a configuration generating a non-necessarily immediate awareness of the alert by the crew member, for example, by a color code distinct from red, amber, and green,

17. The method according to claim 16, comprising the display of the first alert indication with a configuration generating an immediate awareness of the alert by the crew member by a red or amber color code.

18. The method according to claim 16, comprising the display of the second alert indication with a configuration generating a non-necessarily immediate awareness of the alert by the crew member by a color code distinct from red, amber, and green.

19. The method according to claim 15, wherein the display of the first alert indication and the second alert indication comprises the display of an identical alphanumeric message for the first alert indication and for the second alert indication.
